(19) United States
(12) Patent Application Publication
(10) Pub. No.: US 2022/0198062 A1
(43) Pub. Date: Jun. 23, 2022

(54) ADVERSARIAL IMAGE PREPARATION, PROCESSING AND/OR DISTRIBUTION

(71) Applicant: GBL SYSTEMS CORPORATION, Camarillo, CA (US)

(72) Inventors: James Buscemi, Camarillo, CA (US); Jason Laver, Thousand Oaks, CA (US); James Harvey Brodeur, Camarillo, CA (US); Benjamin Baysinger, Camarillo, CA (US)

(21) Appl. No.: 17/558,585

(22) Filed: Dec. 21, 2021

Related U.S. Application Data
(60) Provisional application No. 63/128,182, filed on Dec. 21, 2020.

(51) Int. Cl. G06F 21/62; G06V 40/40; G06V 20/30

(52) U.S. Cl. CPC G06F 21/6254; G06V 20/30; G06V 40/40

(57) ABSTRACT

Methods and apparatus for processing and distributing images are described.

### RELATED APPLICATIONS

The present application claims the benefit of U.S. Provisional Patent Application Ser. No. 63/128,182 which was filed on Dec. 21, 2020 and which is hereby expressly incorporated by reference in its entirety.

### FIELD

The present application relates to content processing and distribution, and more particularly, to method and apparatus for processing and distributing content to obfuscate biometric details and/or other features in image and/or other content that is made publicly available.

### BACKGROUND

Images of people are publicly available from a wide number of sources, many of which are publicly accessible via the Internet. For example, Facebook, TikTok, Instagram and other web sites (or web-enabled application) often include images showing people and, in many cases, with the people in the image being tagged or otherwise identified by information associated with the publicly available image.

Private companies as well as government entities have begun accessing Internet content and creating databases of images of individuals which can then be used to correlate or identify an unknown/untagged person when his/her image is captured. Such private and government services can be used to identify individuals attending lawful protests, walking down a street, or participating in many other lawful activities. They can also be used to identify individuals in a shopping area or other location based on one or more captured images and to then target them with promotions and/or advertisements. Such image-based location information can be useful to sell to law enforcement and/or marketing companies.

While the use of public images and associated information to identify unsuspecting individuals in public areas may be lawful, it represents in many cases a significant loss of privacy. Individuals may, and often do, have an interest in maintaining their privacy and preventing their location being determined and the location information being sold for marketing or other purposes often without their knowledge.

Person identification routines often rely on measuring various biometric information, e.g., face size, distance between facial features such as eyes (e.g., pupils) and nose, ear size, etc. for identification purposes. Thus, even when wearing a disguise or glasses an individual may be identified from a captured image in many cases based on information extracted from publicly available images with which the user's name is associated, e.g., where a person in an image is tagged as being a particular individual.

Posting of images on social media websites such as Facebook, and/or other websites is a common activity for many individuals these days. It would be desirable if individuals posting images could find a way to reduce the risk of the content and images they publicly post or post to limited social groups from being used later in unauthorized person identification operations to identify the individual posting his or her image. In addition, it would be desirable if someone posting an image including multiple people could find a way of reducing the risk that images being posted are used to identify individuals in the image who have not consented to the use of their images for identification purposes.

While methods and apparatus of protecting or reducing the risk of individuals having publicly posted images used to identify one or more individuals in the images are desirable, there is also a need for methods and/or apparatus which reduce the risk of images which were posted by other parties to be used to identify the individual, individuals in the images, objects in the images or to obtain useful technical information from the displayed images without the authorization of the displayed individuals or owners of the displayed objects.

Consider for example the display of an image of an air force plane or navy ship. It might be desirable to alter a portion of the plane or ship to avoid disclosing confidential, technical or secret details. In the case where public images of planes or ships may have been taken and distributed via the Internet it might be desirable to create confusion about the shape or features of a particular aspect of the plane, ship or other object. In such a case it might be desirable, for government or security related reasons to create confusion about the shape or elements of a particular portion of the plane, ship or other object. It would be desirable to be able to create doubt as to the particular shape or features of some objects even after accurate images of the object were distributed to the public.

From the above it should be appreciated that there is a need for methods and/or apparatus which help protect the privacy of individuals by reducing the risk that publicly posted images can be used to identify an individual or individuals in another image, e.g., a person in an image captured potentially without the authorization or knowledge of the person in the captured image being identified. In addition, there is a need for governments, companies and/or government agencies to be able to create doubt or confusion about the shape and/or features of particular objects to make it more difficult to reverse engineer or determine accurate specifications for the objects, e.g., planes, ships or other items which might give insight into there manufacture or operational performance.

### SUMMARY

Methods and apparatus for reducing the risk of publicly or privately posted images of individuals being used to subsequently identify the individuals when they are included in another image are described. In addition, features relating to the risk of publicly available images being used to identify an individual are described.

In accordance with some exemplary embodiments, a user seeking to post images to a public or private site (or web server) is provided the opportunity to have the images being posted automatically modified in a way intended to reduce future value in accurately identifying the individual or individuals in the images. In some embodiments a user is allowed to set, e.g., using a slider, dial or numeric value input, a value used to control a level of image distortion/modification to be applied to an image prior to posting. In some embodiments an overall distortion setting is set by the user alone or in combination with one or more particular distortion settings which control how much of a particular type of image distortion or modification is applied. In other embodiments individual distortion settings are used without an overall distortion setting being used. Types of image distortion which can be, and sometimes are, applied include altering of facial feature spacing, rotation of one or more facial features, feature replacement, e.g., replacement of one or more facial or body features, e.g., with features from another individual, blurring, etc. Unlike image filtering operations intended strictly to improve the individual's appearance, the image distortion operations are intended to make automated person identification operations more difficult to implement and/or less successful by altering one or more of the values normally measured and used in such identification operations. For example, the spacing between a user's eyes, which may be determined based on pupil location, may be altered by altering the distance between a user's eyes. Ear, nose and/or mouth size may be, and sometimes are, altered. Symmetry between features on the left side of a user's face may be, and sometimes are, altered so that features on the left side of a face differ from features on the right side and/or other image distortion operations may be performed. For example, one or more moles or freckles may be added at random or pseudo-random locations, or at a more extreme level a person's face, hands or legs may be, and sometimes are, replaced with corresponding body parts from another individual. In addition to feature spacing and/or size changes, one or more features may be, and sometimes are, rotated with respect to other features in the image and thus the person's face. For example, eyes may be, and sometimes are, rotated or tilted relative the person's nose and/or mouth. This has the effect of altering distance measurements between important facial features, e.g., those which are rotated vs those which are not, making such measurement difficult to use for recognition purposes when comparing to accurate images of the person's face.

In addition to changes that may be, and sometimes are, easily human-perceptible other distortions and alterations may be, and often are, inconspicuous to casual observation, e.g., it is not necessarily obvious that changes were made upon visual examination. Such distortions can still confound automated identification efforts. These distortions may, and often do, include intentional adjustments to the hue, brightness, and saturation of portions of the image data. As an example, patterns of contrast/coloration or modifications to the apparent edges of objects shown in the image may be, and sometimes are, modified. As another example, visual artifacts commonly known as watermarks may be, and sometime are, introduced. Such patterns may be, and sometimes are, based on static imagery that is re-used or repeated for each image. These often-inconspicuous distortions may be, and sometimes are, generated in a random or pseudo-random fashion or are otherwise customized (e.g., to complement the size or coloration of the original image) to improve the disruption of automated person identification operations.

An application (APP) or add in module for an application may be, and sometimes is, loaded onto a user's cell phone or other device used to capture and/or post images. In some embodiments the image processing, e.g., distortion, is performed by a biometric content processing and security system. The biometric content processing and security system is in some embodiments implemented as a separate device from the user device but in other embodiments is part of the user device, e.g., with a processor on the user device performing the image processing, e.g., distortion, operations. In embodiments where the biometric content processing and security system is implemented as a separate device, images are sent to the system for processing prior to distribution and, after processing, the intentionally distorted image or images are provided back to the user device for distribution or are distributed by the system on behalf of the user.

In some embodiments prior to distribution, a user is provided with a distorted image created based on the user setting for review. In this way the user can see the effect of the user selected distortion settings before one or more images are distributed by the user or on the user's behalf. A user may choose to adjust the distortion settings prior to distribution in some embodiments if the sample image is considered unacceptable to the user for some reason.

In various embodiments users can set different distortion setting levels and/or level(s) of each particular type of distortion to be applied on a per web site or distribution end point basis. For example, the user can configure different distortion settings for different servers such as TikTok and Instagram servers. In addition, the user can configure different distortion settings based on whether the group to which the content is being distributed is a private or public group. A set of default distortion setting information can be, and sometimes is, created and is applied when the user has not set specific distortion settings for a particular distribution device or group or the group or device to which the content, e.g., images and/or audio being processed, has not been communicated to the biometric content processing and security system.

Audio distortion settings are also supported and used in some embodiments. Speech frequency and/or speech rate can be, and sometimes are, altered before posting of content associated with an individual. Speech content or portions of the speech are replaced with machine generated speech in some cases. Thus, like image distortion applied to still or video images, audio distortion is applied in some embodiments to reduce the usefulness of a posting for purposes of identifying an individual based on his or her speech included as part of the posting of content to a web site or provision to another distribution device. As with image distortions audio distortions may be, and sometimes are, applied in such a way that the presence of any or some modification is inconspicuous to an ordinary human listener while still confounding automated identification systems.

In some embodiments destination information, e.g., intended distribution information, is provided to the biometric content processing and security system along with image data and/or audio data to be processed prior to distribution. In some cases, multiple destinations are indicated with the biometric content processing and security system applying, in some but not necessarily all embodiments, different distortions to content created for distribution to different destinations from the received content. Thus, in at least some embodiments, where an image is to be processed and distributed to different destinations, the output images and/or audio content for the different destinations generated from a given input image and/or audio file will be different due to the application of different distortion settings for different destinations and/or due to intentional random or semi-random distortion differences intentionally introduced when an image is being processed and distributed to different destinations.

In the case where the user device includes the biometric content processing and security system, the content is modified in the user device, e.g., in accordance with the user settings, prior to content distribution. However, in the case where the biometric content processing and security system is external to the user device, the modified content is returned to the user device for distribution or, alternatively, distributed by the biometric content processing and security system on behalf of the user, e.g., to the intended destinations. Such distribution involves in some cases uploading, e.g., posting, one or more modified images and/or audio to one or more web or social network servers.

While in various embodiments altering of content captured and/or distributed by a user prior to posting is used to decrease the risk or potential for the content to be used to identify the user or other individuals in the images, when included in other content, e.g., images captured by other individuals, other features relate to reducing or minimizing the risk of previously posted content or content posted by other individuals being used in identifying a user of the biometric content processing and security system.

In some embodiments a user is given a chance to choose to participate in an active public biometric obfuscation program. Information indicating whether a user has chosen to participate in such a program can be, and sometimes is, included in a user record in some embodiments. The user record can, and sometimes also does, include accurate biometric information, e.g., one or more images of a user and/or audio, such as speech, corresponding to the user. The user record can, and sometimes also does, include user settings relating to the user selected levels of overall image distortion or amount of particular type of image distortion to be used to distort content prior to distribution. Similar audio distortion level setting information is also included in the user record in some embodiments.

In embodiments where a user has chosen to participate in an active public biometric obfuscation program, distorted or otherwise inaccurate images purporting to show the user are generated and distributed to various websites on the user's behalf. The number of such postings can be user controlled, e.g., based on a user setting indicating a biometric information pollution preference, e.g., with a high preference number indicating a larger number of inaccurate image postings should be generated and a lower preference number indicating a smaller number of inaccurate image postings should be generated. In some embodiments, the number of such inaccurate image postings is determined by an analysis of the number of pre-existing (e.g., authentic and/or undistorted) image postings across various web sites or services by performing a search operation. A number of modified or otherwise distorted images to be posted is then determined as a function of the existing number of accurate postings detected, e.g., 1, 2 or some other number of inaccurate postings being made over time to create a ratio of inaccurate to accurate image postings that creates a desired level of confusion. In some such embodiments images provided by a user which are to be posted are modified prior to posting to distort the image. In addition, additional images may be, and sometimes are, generated and posted, sometimes with false background information, date and location information, to increase or achieve a desired ratio of intentionally inaccurate postings to accurate postings, where the active postings may have been made by individuals other than the individual who is seeking to obfuscate his/her biometric information.

The success of the public biometric obfuscation program is tested in some embodiments by providing accurate and/or distorted images of a user to one or more person identification services and checking the result in terms of how reliably the service or services can identify an individual. In the case where the identification services are able to identify a user to a higher degree of reliability than desired, in some embodiments this triggers the generation and posting of new and/or different distorted images which are posted on behalf of the user to various public sites to create confusion and reduce the risk of identification services which scape images from public web sites to identify the individual in the future. While distorted images of a user are generated and tagged with information indicating they include an image of the user in some embodiments, in other embodiments images of other people are tagged as corresponding to the user and posted. In this way, identification services scraping content from the Internet or other public web sites can have their databases degraded by having inaccurate content incorporated into them as a result of their scraping operations in combination with the intentional posting of inaccurate images tagged with information identifying a user that has chosen to participate in the affirmative public biometric obfuscation program. In the case of the affirmative public biometric obfuscation program the user can, but need not, take action to trigger the posting of images with the system generating and posting to public web sites inaccurate images tagged with user identification information automatically, e.g., based on a schedule or pseudo-random distribution schedule and/or based on the identification test results obtained by submitting real or distorted images of the user to an identification service and then making an automated decision as to whether or not additional distorted images should be posted based on the results provided by the identification service, e.g., whether the service was able to identify the user or not.

The image distortion process and user of the biometric content processing and security system can be triggered as an add in to one or more applications with the content processing, e.g., image and/or audio distortion process, being implemented automatically when a user goes to upload content to a social media website such as Facebook, TikTok or Instagram.

In some embodiments the biometric content processing and security system keeps a record of the distortions applied to user content and/or images uploaded to particular web sites. Thus, the same or similar distortions can be, and sometimes are, repeated over a period of time with regard to images generated for a particular web site. For example, Facebook images of a user may, and sometimes do, have a fake mole appear consistently in multiple facial images and/or the distorted distance between a user's eyes may be repeated in multiple different images. Such repetition has the advantage of building credibility with regard to the accuracy of particular facial distortions since they appear in multiple images, e.g., in a consistent manner, over time but may differ from distortions which are repeatedly introduced into images on another web site. The consistent difference between images on different web sites can present difficulties for an identification service when trying to determine which features can be relied upon to accurately identify an individual and distinguish an image of the individual from images of other people.

The methods and apparatus of the invention are not limited in applicability to biometric applications but can be used to obfuscate object features and/or create doubt about the shape, size or physical characteristics of objects such as planes, ships or other objections or portions of such objects. This can be useful where individuals have captured and distributed images of planes or ships but the movement might want to create confusion about particular features on the planes or ships. In such a case an obfuscation plan can be generated and implemented to distribute modified images of a plane, ship or other object to create doubt about the shape, size or other characteristics of particular portions of the object. This can be useful where a government, company or organization want to make it difficult to reverse engineer an object and/or create confusion as to the objects, e.g., plane's or ship's actual capabilities in terms of flight performance, radar signature and/or other features.

Numerous additional features and embodiments are discussed in the detailed description which follows.

### BRIEF DESCRIPTION OF THE FIGURES

FIG. 1 illustrates a system implemented in accordance with one exemplary embodiment.

FIG. 2 illustrates an exemplary biometric content processing and security system which can be used in the system of FIG. 1 as a stand alone system or as a component in a user device or another device in the system.

FIG. 3 illustrates an exemplary user record which can be created, stored and used by the example biometric content processing and security system of the present invention shown in FIG. 2.

FIG. 4 illustrates the steps of an exemplary security and content processing routine which is implemented by the content processing and security system shown in FIG. 2 in some embodiments.

FIG. 5 illustrates the steps of an exemplary user record and settings update routine that may be called by the routine shown in FIG. 4.

FIG. 6 illustrates the steps of an exemplary active obfuscation routine that may be called by the routine shown in FIG. 4.

FIG. 7 shows an exemplary user device, e.g., cell phone that can interact with an external content processing and security system as part of posting content and/or which includes an internal content processing and security system, to alter content before posting to one or more web sites and/or as part of implementing an active obfuscation program directly from the user device.

FIG. 8 shows another exemplary method implemented by the content processing and security system shown in FIG. 2 in accordance with some embodiments that support obfuscation of images of individuals and/or objects.

FIG. 9A shows the steps of a first part of an exemplary obfuscation plan and image modification routine, capable of generating an obfuscation plan and/or altered images, that can be called by the method shown in FIG. 8.

FIG. 9B shows the steps of a second part of an exemplary obfuscation plan and image modification routine that can be called by the method shown in FIG. 8.

FIG. 9C shows the steps of a third part of an exemplary obfuscation plan and image modification routine that can be called by the method shown in FIG. 8.

FIG. 9 shows how FIGS. 9A, 9B and 9C can be combined to form a flow chart showing the steps of the obfuscation plan and image modification routine that can be called by the method shown in FIG. 8.

FIG. 10 illustrates an exemplary user record that includes information and images that can be used by the methods of FIGS. 8 and 9 to obfuscate images, audio or object shapes for security or other reasons.

### DETAILED DESCRIPTION

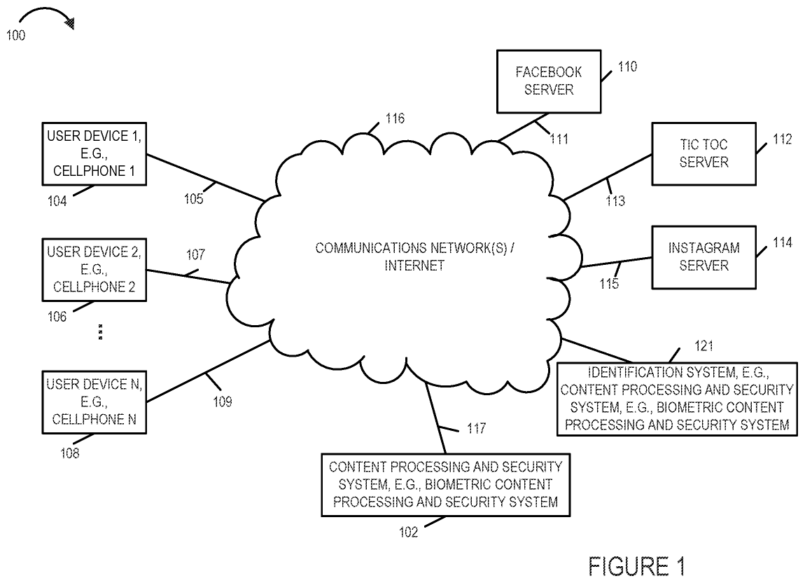

FIG. 1 illustrates a system 100 implemented in accordance with one exemplary embodiment. The system 100 includes a plurality of user devices 104, 106, 108, e.g., cell phones, personal computers with cameras, or other devices capable of capturing and/or posting content, e.g., images and/or audio, to servers 110, 112, 114 of one or more social networking sites or other web sites. In the FIG. 1 example the user devices 104, 106, 108, are coupled via links 105, 107, 109, to a communications network 116, e.g., the Internet, which is also coupled via links 111, 113, 115 and 117 to servers 110, 112, 114 corresponding to different content distribution platforms or social networking sites and to a content processing and security system 102, capable of processing biometric content such as images of people and/or content corresponding to objects such as images of planes, boats, cars, etc., which is implemented in accordance with the invention.

The content processing and security system 102, sometimes referred to as a biometric content processing and security system since images and/or audio content of people can be processed, is capable of altering image and/or audio content provided by one or more of the user devices 104, 106, 108 to reduce the usefulness of the content to other programs which might attempt to use it to facilitate identification of individuals in other images, e.g., images submitted to an identification system for identification 121 purposes. The identification system 121 may be run by a third party who scrapes tagged images and/or audio from web sites and servers on the Internet and uses them to train an identification system to identify people in captured images or recordings, e.g., often without the knowledge of the person being identified.

While shown as a separated device from the user devices 104, 106, 108 in some embodiments the biometric content processing and security system 102 is integrated into a user device as an integrated system 102′. In such cases, images and other content can be processed inside the user device 104, 106, 108 without the need to communicate content to be processed over network 116 to the external biometric content processing and security system 102.

While the servers 110, 112, 114 are shown as an exemplary Facebook server 110, TikTok server 112 and Instagram server 114 the servers to which content processed by the biometric content processing and security system can be any of a wide range of servers or other devices capable of receiving, processing and/or distributing content, e.g., via the Internet 116.

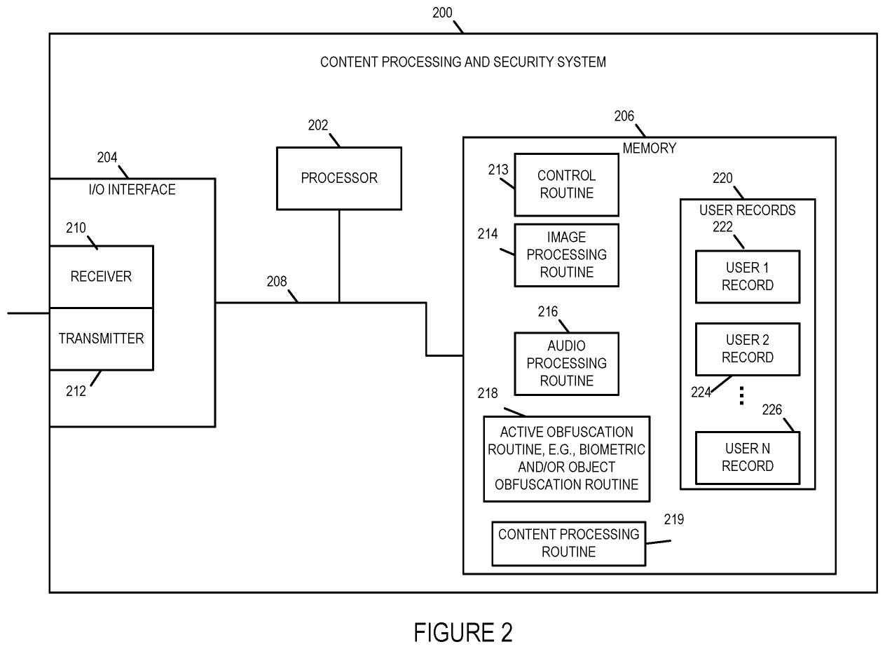

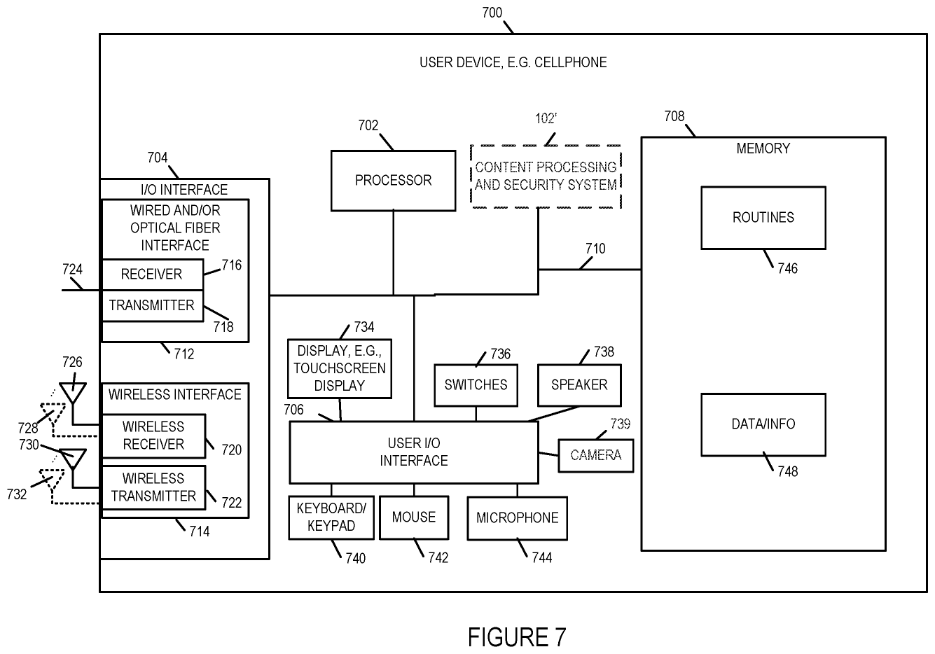

FIG. 2 illustrates an exemplary content processing and security system 200 which can be used as content processing and security system 102 shown in FIG. 1 or which can be used as the integrated system 102′ included in the exemplary user device 700 shown in FIG. 7 which can also be used as any one of the user devices 104, 106, 108 of FIG. 1. The system 200 includes an input/output interface 204 which includes a receiver 210, e.g., for receiving content to be processed and/or user related information including user setting information, and a transmitter 212 for sending content and/or responding to user input. The I/O interface 204 is coupled by bus 208 to a processor 202 and a memory 206. The processor 202 controls the system 200 to implement content processing and/or other operations in accordance with the invention, e.g., under control of one or more of the routines 213, 214, 216, 218 included in memory 206 in accordance with the information, e.g., user records 220 stored in the memory 206. The user records 220 include a different user record 222, 224, 226 corresponding to different users of the system 200. The users may be, and sometimes are, the users of the user devices 104, 106, 108. Accordingly, in some embodiments user record 1 222 corresponds to the user of user device 1 104, user record 2 224 corresponds to the user of user device 2 106 and user N record 226 corresponds to the user N who uses user device N 108.

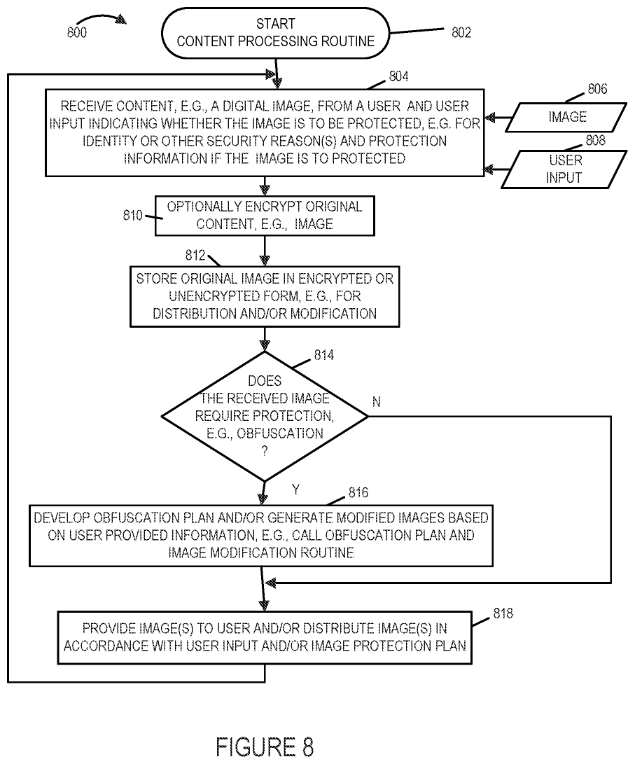

The routines include a control routine 213 which, when executed by processor 202, controls the biometric content processing and security system 202 to operate in accordance with the invention, e.g., to perform one or more steps of methods shown in the flow charts included in this application or described in this application as being implemented by the biometric content processing and security system. The routines also include an image processing routine 214 and an audio processing routine 216. The image processing routine 214 distorts images in accordance with the invention, e.g., in accordance with the distortion settings included in the user records corresponding to the user whose content is being distorted. The image processing routine 214 generates from an input image one or more distorted images which are to be distributed, e.g., posted, on one or more web sites. The audio processing routine 216 generates from input audio, e.g., recorded speech, one or more distorted audio files which are to be distributed, e.g., posted, on one or more web sites. The active biometric obfuscation routine 218 automatically generates images and posts them with information identifying them as corresponding to particular users in an attempt to generate many different images and/or audio postings corresponding to an individual whose biometric information, e.g., images or audio, is to be protected, e.g., by creating confusion as to which images and/or audio can be used to accurately identify a particular individual. The active biometric obfuscation routine 218 maybe called when a user initially selects participation in a biometric or other content obfuscation program with modified images and/or other content then being generated for distribution. Content processing routine 219 is stored in memory and called when a user seeks to post new content. If participation in an obfuscation program has been selected calling content processing routine 219 will result in content modification prior to posting of the content. In some embodiments. FIG. 8 shows an exemplary routine which can be used as the content processing routine 219.

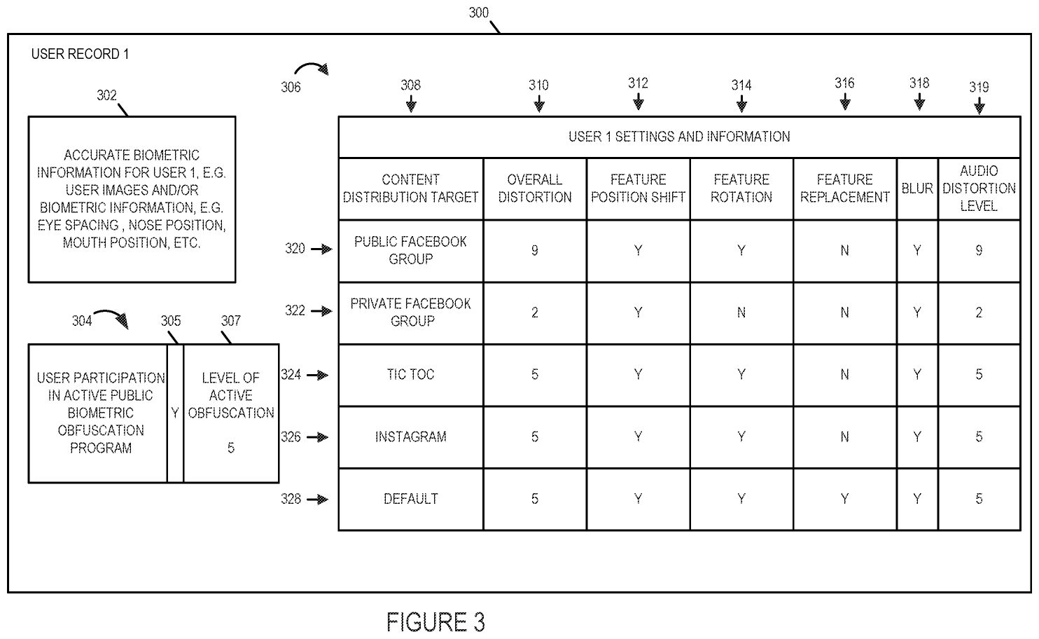

An exemplary user record 300 which can be used by the biometric content processing and security system 102, 102′ or 200 shown in any of the other Figures of this application is shown in FIG. 3. The user record 1 300 may, and in some embodiments does, correspond to user 1, the user of user device 1 104. Different records of the type shown in FIG. 3 are maintained for different users with the user records, depending on the implementation, including one, some or all of the data fields shown in the record 300.

The exemplary user record 300 includes accurate biometric information 302 for user 1, the user to which the record corresponds. The information 302 may include, e.g., user images, user audio and/or user metrics, e.g., numerical values relating to user features that can be generated by processing images and/or audio. User metrics may include measurements of facial features such as nose, ear or eye size, distances between such features and/or position information indicating the location of one or more features on the user's face, e.g., the location of a freckle, wart, etc. The accurate biometric information 302 is used in some embodiments to generate intentionally inaccurate images or audio which can be posted, e.g., as part of a biometric obfuscation program, to create confusion about the actual metrics which should be used to identify the user. For example, an accurate image of a user may be retrieved from memory portion 302, altered and then posted with the image being identified, e.g., tagged, on a web site as an image of user 1. The intentional alteration is done in some embodiments in a way intended to defeat, confuse or create doubt about the user's actual image features by having feature spacing, distortions or marks such as freckles or moles in locations that differ from one posted image to another and also differ from the actual features, spacings and locations of user 1's face. Effective alterations may also include subtle changes to the overall image appearance and/or include the sum of several small distortions and thus be inconspicuous to a casual visual inspection but still confound automated recognition systems. The user record 300 also includes information 304 about a user's participation or lack of participation in an active public biometric obfuscation program in which inaccurate images and/or other biometric data are generated, tagged with the user's name, and posted to associate a variety of different, intentionally inaccurate images, with the user to increase the difficulty of using publicly available images to identify the user. Information 304 includes a field 305 with a value indicating whether the user is participating in the active public biometric obfuscation program, e.g., a Y value in the FIG. 3 example indicating participation and information 307 indicating a level, e.g., 5 on a scale of 0 to 9, of active obfuscation to be implemented. In some embodiments the higher the level of obfuscation the more inaccurate images will be generated and posted. Thus a 5 indicates an intermediate level of active image generation and posting, while a 9 would result in considerably more inaccurate images being generated and posted at various web sites. Different users can decide whether or not to participate in the active public biometric obfuscation program with their decision being reflected in a Y or N in field 305 and field 307 including a level specified by the user or a default value in the event a user decides to participate but does not set the level of active obfuscation to be implemented.

User settings and information 306 includes various user settings used to control the amount of image and/or audio distortion to be applied to content the user provides for processing prior to distribution. The user can set different levels of distortion to be applied for content being distributed to different destinations or groups. Each row 320, 322, 324, 326, 328 corresponds to a different content distribution destination, e.g., with row 320 corresponding to a public Facebook group, row 322 corresponding to a private Facebook group, row 324 corresponding to TikTok, row 326 corresponding to Instagram and row 328 providing default settings to be used for an unknown destination or when a destination is specified by user settings were not set for the particular identified content destination that is indicated along with content is provided to be processed.

The first column 308 indicates the content destination, the second row 310 specifies an overall level of image distortion to be applied with a higher number indicating more distortion to be applied and a lower number indicating less distortion of images, e.g., facial features. Columns 312, 314, 316, 318 correspond to settings that are to be used to control the amount of image distortion of the type indicated at the top of the column. In the FIG. 3 example columns 312, 314, 316, 318 include Y/N values indicating that the particular type of distortion is to be applied, e.g., when a Y is present and not applied when an N is present. While two levels (on or off) are shown, a range of levels may be, and sometimes is, specified as a numerical value, e.g., from 0 to 9, in the fields included in columns 312, 314, 316, 318. Column 319 is used to specify an amount of audio distortion or modification to be applied on audio content being distributed to the destination indicated in the corresponding cell of column 319.

Note that the user can specify different amounts and/or types of distortion to be introduced for different intended content destinations. For example, less distortion may intentionally be introduced into content intended for private groups than the more readily accessible public groups. Each user can set and configure the amount of image and/or audio distortion to be implemented accordingly to their own preference and desire to limit the usefulness of the content for user identification purposes.

Because a user may have difficulty in understanding the effect of various distortion settings after generation of an intentionally distorted image or audio, the user is, in some embodiments, provided an opportunity to review the generated image or audio on the user's device, e.g., cell phone, prior to distribution. Thus, in many embodiments the user can adjust the settings to obtain an image they are comfortable distributing with a new distorted image being generated and presented to the user for review until the user affirmatively approves an image for distribution or the user fails to alter the user setting that control distorted image generation in a predetermined time after the user is presented with the image on the display device of the user's cell phone or other user device.

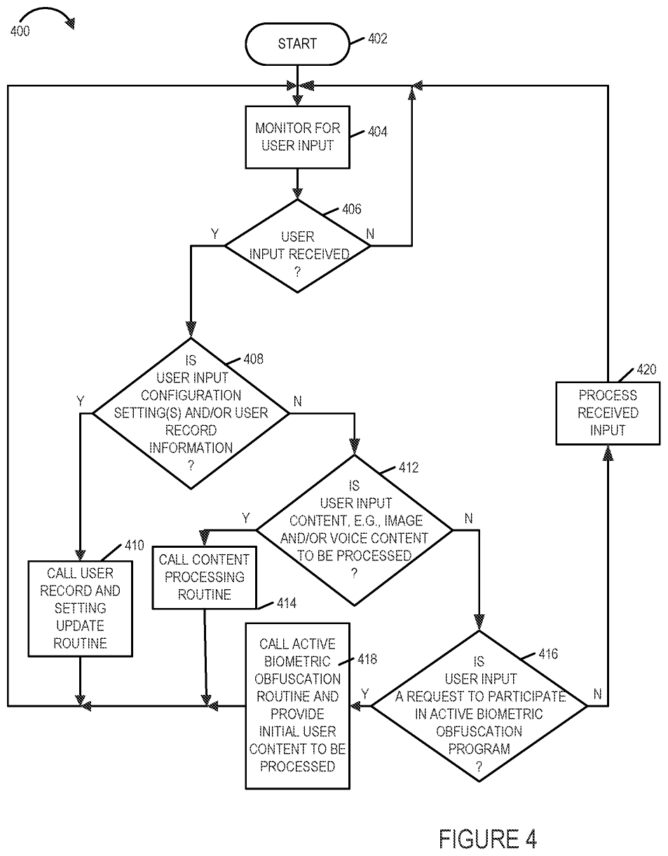

FIG. 4 illustrates the steps of an exemplary security and content processing routine 400 which is implemented by the content processing and security system shown in FIG. 2 in some embodiments.

The routine 400 starts in step 402, e.g., with the content processing and security system 200 being powered on. Operation proceeds from step 402 to step 404 in which the system 200 monitors for user input. In step 406 a check is made to determine if user input was received, e.g., via the I/O interface 204. The input may be, and sometimes is, an image captured by a camera 739 included in the user's cell phone of the user and may also include corresponding audio of the user speaking with the speech having been captured by a microphone 744 include on the user device. If in step 406 user input is determined to have been received, operation proceeds to step 408; otherwise operation returns to monitoring step 404.

Steps 408, 412, 416 are used to control which processing routine is called based on the received user input. In step 408 a check is made as to whether user input in the form of one or more configuration settings and/or other user record information was received. If user setting information or user record information was received operation proceeds to step 410 in which a user record and setting update routine is called to update the information stored in the user record corresponding to the user who supplied the received input data, e.g., settings or other information such as accurate images of the user.

If in step 408 it is determined that the user input did not include configuration settings or other user record information, operation proceeds from step 408 to step 412 in which a check is made to determine if user content, e.g., image and/or voice content, to be processed was received. If in step 412 it is determined that image content to be processed, e.g., intentionally distorted prior to distribution, was received, as call is made to a content processing routine in step 414. If, however, the input was not content to be processed, operation proceeds to step 416 in which a check is made to determine if the user input is control information relating to participation in an active biometric obfuscation program. If the input is information indicating a user wants to participate in the active biometric obfuscation program, stop participation in the active biometric obfuscation program or alter a setting relating to the program, e.g., an activity level setting, operation proceeds from step 416 to step 418 in which a call is made to the active biometric obfuscation routine to update information in the user record relating to the program. If the input does not relate to the obfuscation program, operation proceeds to step 420 in which the input is processed in a normal manner.

Operation is shown returning to step 404 from steps 410, 414, 418 and 420 to show that the monitoring for user input and processing of user input, e.g., corresponding to one or more users, is performed by the biometric content processing and security system 200 on an ongoing basis.

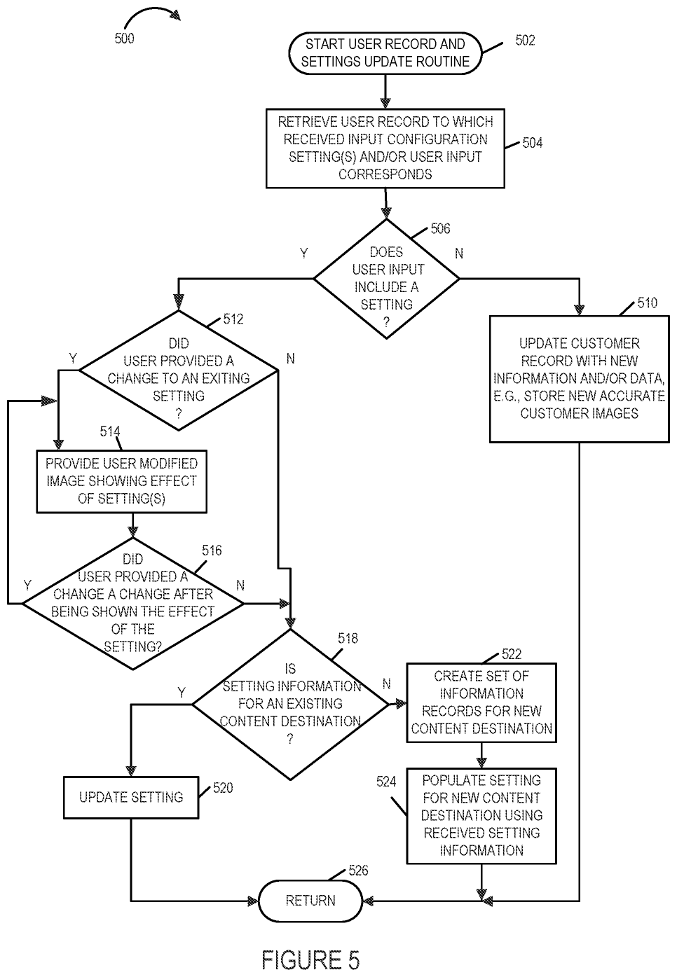

FIG. 5 illustrates the steps 500 of an exemplary user record and setting update routine that may be called by the routine shown in FIG. 4.

The routine starts in step 502 when it is called, e.g., from step 410 of the method shown in FIG. 4. Then in step 504 a user record is retrieved, e.g., from storage, with the retrieved user record corresponding to a record for which user input and/or settings is to be updated or modified. Operation proceeds from step 504 to step 506, in which a check is made to determine if user input to be processed includes a user setting. If the user input includes a user setting, e.g., an image modification setting used to generate altered image, operation proceeds to step 512 in which a check is made as to whether the user provided a change to an existing setting, e.g., an image alteration or distortion setting. If the user altered an existing setting, operation proceeds from step 512 to step 514 in which the user is provided, e.g., shown, a modified image showing the effect of the updated setting. This allows the user to get an understanding of how the user update will affect image modification when used to generate modified images. Then in step 516 a check is made to determine if the user provided a setting change after being shown the effect of the updated user setting. If the user made a change after being shown the modified image based on the user setting, operation proceeds to step 514 in which the user is shown another image generated based on the new setting information.

If in step 516 no additional user change was detected, operation proceeds to step 518. If in step 512 it is determined that the user provided setting information is not for an existing setting, e.g., modification setting stored in memory, operation proceeds to step 518 in which a check is made to determine if the setting information is for an existing content destination, e.g., a web site or other destination for which content modification, e.g., image or audio modification information, is already stored.

In step 518 a check is made if the current setting is for an existing content destination, e.g., web site. If the updated setting is for an existing content destination, the image modification information associated with that destination is updated in step 520 before operation returns in step 526 to the processing point from which the record updating routine 500 was called.

If however in step 518 it is determined that the updated or new setting is not for an existing content destination, operation proceeds to step 522, in which an information record or set of information records is created for the new content destination. Then in step 524 the setting or setting for the new content destination is populated in the created record for the new destination. For example, the first time a user wants to set voice or image modification records for content to be posted to Facebook, the user may specify an image and/or audio distortion technique or level to be applied before an image is distributed to the Facebook website, e.g., web server. Operation proceeds from step 524 to return step 526.

If in step 506 it was determined that the user input did not include a user setting, e.g., a content modification setting, operation proceeds from step 506 to step 510, in which the customer record, e.g., in memory 206 of the system shown in FIG. 2, corresponding to the customer providing the information, is updated with the new information and/or data which may include new accurate customer images to be processed, stored and/or distributed. Operation proceeds from step 510 return step 526.

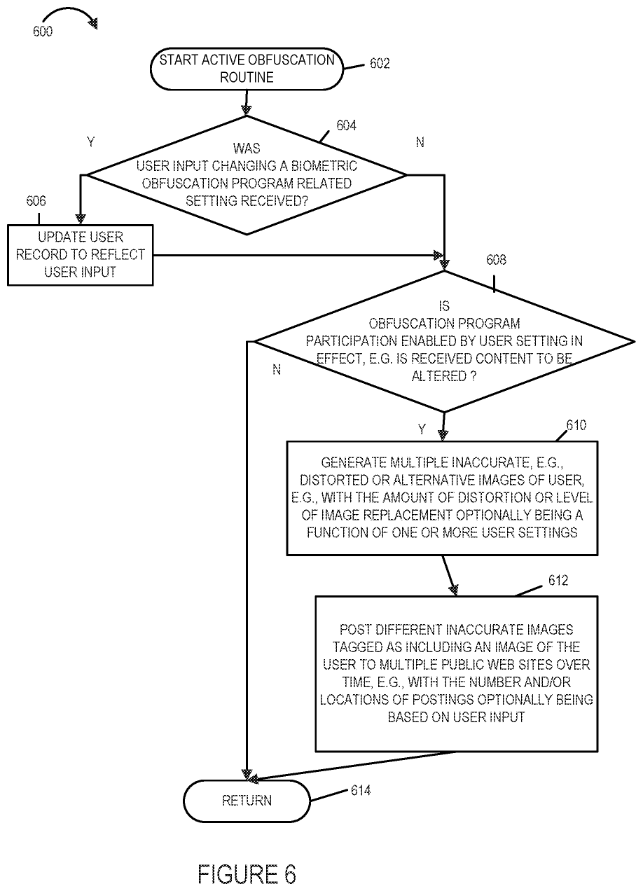

FIG. 6 illustrates the steps 600 of an exemplary active obfuscation routine that may be called by the routine shown in FIG. 4. The routine is well suited for obfuscation of biometric content but can be used to obfuscate other types of images as well.

The routine, e.g., method, shown in FIG. 6 begins in step 602, e.g., with it being executed by the processor of the system shown in FIG. 2. Operation proceeds from start step 602 to step 604 in which the type of user input that was received is checked to determine if was user input changing an obfuscation related setting, e.g., a biometric obfuscation setting used to control the alteration of images and/or content. If in step 604 it is determined that the user supplied input is an input changing an obfuscation related setting, operation proceeds to step 606 in which the user record corresponding to the user providing the input is updated to reflect the user input.

If the user input is not an obfuscation relating setting input but rather content to be processed, e.g., an image, audio or video or some combination thereof, operation proceeds from step 604 to step 608, in which a check is made to determine if the user to which the content being processed is participating in the obfuscation program. Thus, in step 608 the system, e.g., the system of FIG. 2, implementing the steps shown in FIG. 6 determines in step 608 if obfuscation is to be implemented on received content. If in step 608 it is determined that the user to which received content corresponds has not enabled participation in the obfuscation program, e.g., biometric obfuscation program, operation proceeds from step 608 to return step 614 where processing returns to the routine or step from which the obfuscation routine 600 was called. However, if in step 608 it is determined that distorted images are to be generated, e.g., because biometric obfuscation program participation has been enabled or for some other reason, operation proceeds to step 610.

In step 610 distorted and/or otherwise altered content is generated from the user provided content or content corresponding to a user. Multiple inaccurate or alternative images of a user are generated in step 610 in some cases when the input is an image. The amount of distortion and/or level of image replacement is optimally a function of one or more user settings, e.g., settings indicating what portion of a face or image is to be distorted, how the image is to be distorted and/or the level of distortion to be applied to generate the inaccurate image(s). The distortion applied may be, and sometimes does, depend on which web site the content, e.g., image, is to be provided to with the user specifying different distortions or levels of distortion for different web sites in some cases. With inaccurate images or other content having been intentionally generated in step 610, operation proceeds to step 612 in which the content, e.g., in accurate images having been tagged and including an image of the user, are posted to one or more public web sites, e.g., over time. The number of inaccurate postings, time period over which inaccurate tagged images are posted and/or web site locations where the altered content is posted may be, and sometimes is, based on user input, e.g., specifying the duration and/or period over which an obfuscation plan is to be implemented and/or the number of accurate images that are already publicly available on such websites. For example, it may be, and sometimes is, the objective of an obfuscation program to dilute the reliability of tagged images publicly available by knowingly posting more inaccurate images over time than there are accurate images publicly available to create confusion as to which images are accurate and which are not accurate.

Operation proceeds from step 612 to return step 614 in which processing returns to the routine or step from which the active biometric obfuscation routine 600 was called.

FIG. 7 shows an exemplary user device 700, e.g., cell phone that can interact with an external biometric content processing and security system as part of posting content and/or which includes an internal biometric content processing and security system, to alter content before posting to one or more web sites and/or as part of implementing an active biometric obfuscation program directly from the user device.

The user device 700 includes an I/O interface 704 which is coupled by bus 710 to a processor 702, biometric content processing and security system 102′ which is included in the user device in some, but not all, embodiments, memory 708 and a user I/O interface 706. The I/O interface 704 includes a wired and/or optical fiber interface 712 which includes a receiver 716 and transmitter 718 coupled to a wire or optical fiber 724. The I/O interface 714 also includes a wireless interface 714 including a wireless receiver 720 and a wireless transmitter 722. Wireless receiver 720 is coupled to one or more antennas 726, 728, while wireless transmitter 722 is coupled to one or more antennas 730, 732.

The user device 700 can send and receive images via interface 704 and can send user setting information to a biometric content system via interface 704 when an external system is used. The user device 700 can also post and distribute images and other content via the interface 704. In some embodiments the user device 700 interacts with an external content processing and security system 102 while in other embodiments the content processing system used to alter and distribute content is implemented on the user device as system 102′. System 102′ may, and sometimes does, include the same or similar elements to the system 200 shown in FIG. 2.

User I/O interface 706 is coupled to a display 734, keyboard/keypad 740, a mouse 742, microphone 744, camera 739, speaker 738, and switches 736. Through input devices such as touchscreen 734 and keyboard 740 the user can input control and/or content, e.g., image, alteration or modification information. Such information can be and is communicated to the content processing and/or security system 102′, 200, 102 and/or 121. Content can be, and sometimes is, captured by the camera 739 and or microphone 744 and supplied to the content processing and security system 102′, 200, 102 and/or 121 for processing. Memory 708 stores routines 746 and data/information 748. Data/information can, and sometimes does, include captured and/or altered images and/or other content sent for processing and/or generated by processing in accordance with the invention. The routines 746 include computer executable instructions which, when executed by the processor 702 or a processor in the content processing and security system 102′ control the user device 700 and/or content processing and security system to implement the steps of one, more or all of the routines or methods described in the present application.

FIG. 8 shows the steps an exemplary content processing routine 800 implemented in accordance with one exemplary embodiment of the invention. The routine can be stored in the memory 206 of the content processing and security system 200, 102′ and/or routines 746 included in memory 708 of the user device. It should be noted that the content processing system 200 can be used as either of the systems 102, 121 shown in FIG. 1 and that the user device shown in FIG. 7 can be used as any of the user devices shown in FIG. 1.

The content processing routine 800 begins in step 802 when it is called, e.g., from step 414 of the routine shown in FIG. 4 or from another step. Operation proceeds from start step 802 to step 804 in which content to be processed is received, e.g., from a user device or another device. The content may be, and sometime is, a digital image, audio and/or video content. While described primary in the context of an image alteration example, audio content would be processed, altered and posted in the same or similar manner with the alteration being an audio content alteration as opposed to image content alteration. The received content, e.g., received image is represented as image 806. In step 804 user input 808 indicating whether the content, e.g., image is to be protected, e.g., for identity or other security reasons is received. In addition, information about how the image is to be modified is also received. The information shown as being received in step 804 may be received as user input at various times and accessed, e.g., retrieved from a user record, and supplied to the routine 800 when a user indicates content, e.g., a captured image, is to be distributed or otherwise processed for distribution. A call to the routine 800 may, and sometime does, occur automatically when a user attempts to post content from his/her user device to Facebook or another website/content distributer. Accordingly, while distribution to a website is discussed this is to include distribution of content to servers, media distributors and/or other content outlets or devices. Operation proceeds from step 804 to step 810 which is an optional step. In step 810 the original, i.e., accurate, content to be processed is encrypted. In step 812 the original received content, e.g., image is stored, e.g., in memory in encrypted and/or unencrypted form. If saved in encrypted form the received content is decrypted when needed for use by other processing steps. Storing the received content in encrypted form reduces the risk someone will be able to easily access the content if the user device on which it is stored is lost or the contents of memory copied.

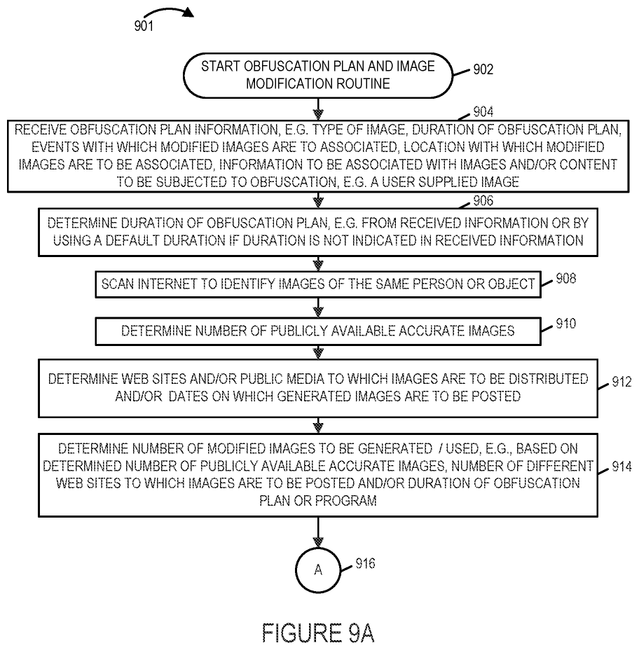

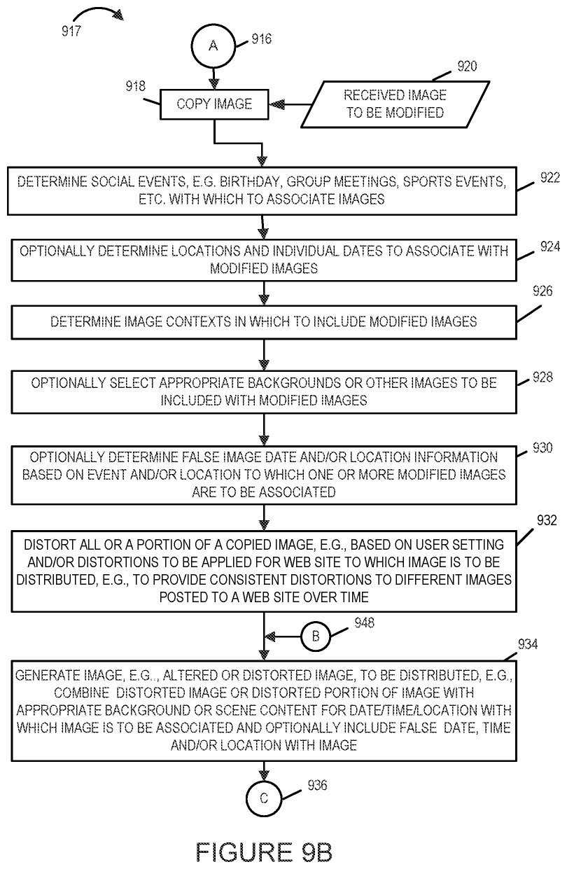

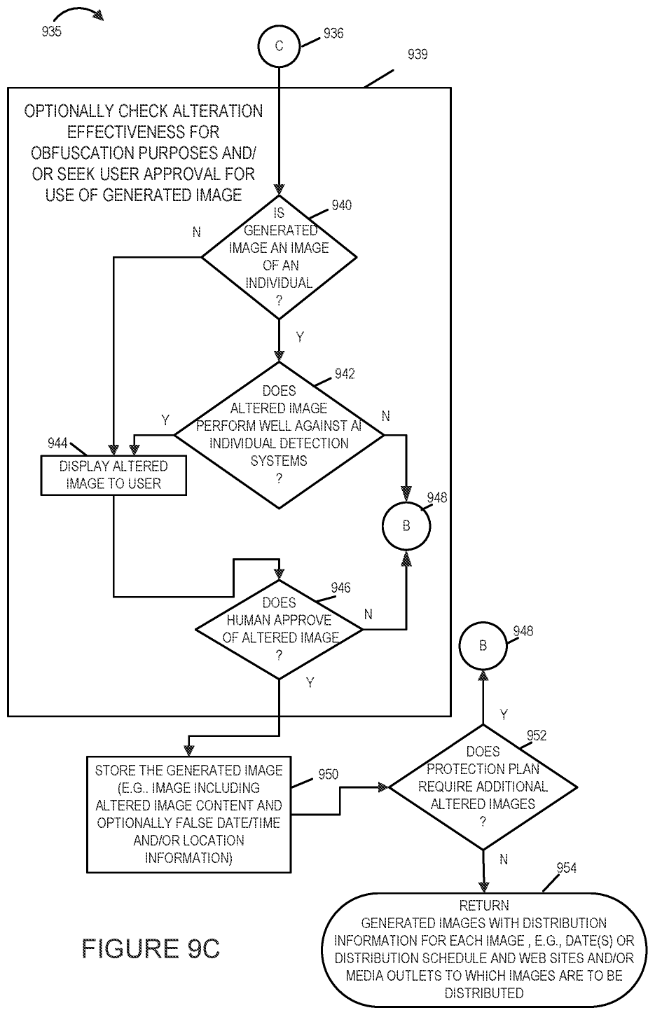

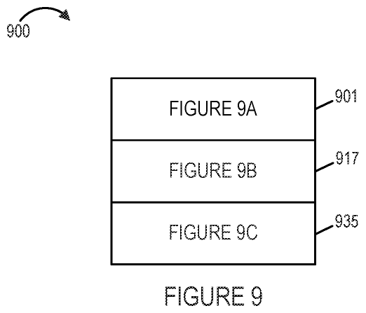

Operation proceeds from storage step 812 to determination step 814 in which a determination is made if the received content, e.g., received image, requires obfuscation, e, g, because a user has selected participation in an obfuscation program which requires altering such content prior to distribution. If in step 814 it is determined that obfuscation, and thus image alteration, is not required prior to distribution, operation proceeds from step 814 to step 818. However, if in step 814 it is determined that the received content is to be the subject of obfuscation, e.g., because a user has selected such content to be subject to, or part of, an active obfuscation program, operation proceeds from step 814 to step 816. In step 816 an obfuscation plan and/or modified content, e.g., modified images, is generated for the received content. In some embodiments this is done by a call to an obfuscation plan and image modification routine such as the one shown in FIG. 9. Operation proceeds from step 816 to step 818.

In step 818 content is provided, e.g., distributed to the user and/or to one or more web sites. If the content, e.g., received image, was subject to obfuscation, the distribution in step 818 will be of one or more modified images generated from the received image which are distributed in accordance with a generated obfuscation plan. If the received content was determined in step 814 not to be a subject of obfuscation, the content, e.g., received image, will be distributed in step 818 in accordance with the user's instructions without alteration. In the case where an obfuscation plan is implemented, multiple images or altered versions of the received content may be generated and distributed to different web sites at the same or different times. Thus, in the case of obfuscation, multiple different images may be, and sometime are, generated and distributed from a single received image. This can make it difficult for entities that do not have access to the original image to determine what, if any, of the distributed images includes reliable image content.

Operation is shown proceeding from step 818 back to receive step 804 to show that the routine 800 can be used on an ongoing basis to process content, e.g., as images or audio recording are captured and supplied for processing.

FIG. 9 shows an obfuscation plan and image modification routine 900 which includes a first part 901 shown in FIG. 9A, a second part 917 shown in FIG. 9B and a third part 935 shown in FIG. 9C.

The method 900 starts in step 902 shown in FIG. 9A when the routine 900 is called, e.g., by step 816 of the method shown in FIG. 8. Then in step 904 obfuscation plan information is received, e.g., by retrieving it from memory or under control of the routine which called the obfuscation plan and image modification routine. The information received in step 904 includes, e.g., a duration of the obfuscation plan to be implemented, a time period in which the plan is to be implemented, information indicating events such as sporting events, air shows, a birthday party, class trip or other event with which one or more modified images are to be associated, a location or locations with which one or more modified images are to be associated, e.g., event locations, and/or other information, e.g., tags such as information identifying an individual or object in the content, which are to be associated with content such as one or more images and/or voice recordings. Content such as an image to be subject to obfuscation can be, and sometimes is, also received in step 904. The content to be subject to obfuscation may be, and often will be, an image of a person or object which has not been altered. The object may be, and sometimes is, a plane, ship or another object which the information indicating a portion of the object which is to be the subject of a particular specified alteration as part of the obfuscation program to be developed.

Operation proceeds from step 904 to step 906 in which 906, in which a duration of the obfuscation plan to be implemented is determined, e.g., from received information and/or by using a default duration, e.g., 3 or some other user set number of months, if a duration is not indicated in the received information.

Operation proceeds from step 906 to step 908, which is performed in some, but not all, embodiments. In step 908 a check is made to identify publicly available images corresponding to the image to be subject to the obfuscation plan. This involves, in some cases, where the received unaltered image is an image of a person, searching the Internet to identify images of the person. These may include images which are tagged as corresponding to the person which are accurate as well as images which have been altered and are not accurate. Similarly, if the image to be subject to obfuscation is an image of an object, step 908 would identify images of the object, e.g., plane.

In step 910 the number of publicly available accurate images is determined, e.g., by comparing the images obtained in search step 908 to the accurate actual image to be subject to obfuscation. The number of publicly available accurate images determined in step 910, e.g., based on an Internet search, is useful in determining how many altered images should be generated and distributed to “dilute” the accurate publicly available images and where the inaccurate images should be distributed to counter accurate images. For example, if two tagged accurate images are found on Facebook, it might be useful to distribute three times as many, e.g., 6 altered images of the same person or object to Facebook. This can create confusion as to what the person actually looks like or what features are actually in the object purported to be shown in the public images. The goal in some cases is to determine a number of altered images to generate and post to exceed the number of actual accurate images by some predetermined amount, which in some cases is a multiple of the number of actual accurate images detected on a website or on the Internet in general. This in step 910 in some embodiments a number of publicly available accurate images on the Internet and/or a website is determined.

In step 912 web sites and/or public media to which images are to be distributed and/or dates on which generated images are to be posted is determined. In some embodiments this involves identifying web sites including images on which accurate images of the person or object are already posted. The determination of dates may be, and sometimes is, based on dates of events, e.g., shows, parties and/or other activities which are likely to coincide to the capture and posting of a real image of the person or object. For example a birthday might be, and sometimes is, determined to be a date for posting an altered image of a person at what is indicated to be his/her birthday party or a birthday party of a friend. A date for posting an altered image of a plane may be, and sometimes is, determined to be the date of an airshow at which the plane was indicated to be present and/or a date at which a plane was publicly reported to be sighted at an air force base by a member of the public.

With distribution web sites and/or distribution dates for altered images having been determined in step 912, operation process to step 914. In step 914 a number of modified, e.g., altered, images to be generated and/or used is determined, e.g., based on the determined number of publicly available accurate images, number of different web sites to which images are to be posted and/or duration of the obfuscation plan or program. In some cases the number of altered images to be generated is a multiple, e.g., 2, 3 or some other multiple, times the number of publicly available accurate images. The multiple can be, and sometime is, preconfigured by the user, e.g., on a per website basis in some embodiments. For example, a user can indicate that the number of inaccurate images posted on Facebook of a particular person should be 2 times the number of accurate images on Facebook or a number needed to achieve an inaccurate to accurate image ratio of the person of 2 to 1. A different ratio can be, and sometimes is, configured by the user for the same person and a different website.

Operation proceeds from step 914 of FIG. 9A to step 918 of FIG. 9B via connecting node A 916. In step 918 the received image 920, e.g., the user provided accurate content which is to be subject to modification as part of the obfuscation process is copied in step 918 so that it can be modified or altered without affecting the original accurate image. Operation then proceeds to step 922, in which social events, e.g., birthdays, group meeting, sports events, etc. with which modified images are to be associated are determined, e.g., from user supplied information and/or publicly available event information such as sports event schedules or air show schedules. The dates of such events are also determined from public schedules or user provided information. This may occur in step 922, 924 or step 930.

Operation proceeds from step 922 to step 924 which is an optional step. In step 924 locations and/or dates to associate with individual modified, e.g., altered, images which are generated are determined. The association or tagging of images with dates and locations which are credible increases the likelihood that the images will be accepted as being accurate.

Operation proceeds from step 924 to step 926, when step 924 is implemented, or directly from step 922 to step 926 in embodiments where step 924 is not implemented. In step 926 image context in which to include modified images are determined. This is useful when a modified image of a person or object is to be mixed or merged with an accurate image of an event, e.g., a sporting event or air show.

Operation proceeds from step 926 to step 928, in which appropriate backgrounds or other images to be included with a modified image or images are selected. This step is performed in embodiments where inaccurate images are generated by using backgrounds or content taken from other images and can be skipped if only a portion of a person or object is to be modified in the user provided image.

Operation proceeds from step 928 to step 930. In step 930, which is another optional step, false image date and/or location information to be associated with a generated image including intentionally inaccurate information is determined. Such information can be determined from publicly available event information and/or user provided information such as home address information or the address where a birthday party was held.

Operation proceeds from step 930 to step 932. In step 932 all or a portion of the copied image is distorted. The distortions, e.g., alterations can be, and sometimes are, based on user information or settings and can be web site dependent with similar distortions being made to multiple images generated for distribution to a particular website. Thus distortions of a person's image or an object will be consistent on a web site as different images are posted over time. This increases the chance that a person or object will be perceived as having the distorted image features as opposed to actual features that might be visible in unaltered images which appear less frequently on the same website.

With distorted image content having been generated in step 932, operation proceeds to step 934, in which an image including distorted image content is generated for distribution. This can include incorporating the distorted image content into an image with other content, e.g., background content of an event and/or simply combining the intentionally distorted/altered image content with inaccurate date, time, and/or location information which was selected to be credible. The image may be, and sometimes is, tagged in step 934, e.g., identified as being an image of a particular person or object, despite included intentional alterations to the image of the particular person or object.

With an altered image having been generated for possible distribution in step 934, operation proceeds via connecting node C 936 to step 939 of FIG. 9C which is used in some but not all embodiments.

In step 939 which is an optional step, the altered image is checked for effectiveness for obfuscation purposes and/or user approval of the altered image generated in step 934 is sought from a user on whose behalf the altered image is generated. In cases where optional step 939 is omitted, connecting node 936 brings operation directly to step 950.

Step 939 includes various sub-steps including step 940, 944, 942 and 946. In step 940 a check is made to determine if the generated altered image is an image of an individual, e.g., person. If the altered image is a person operation proceeds to step 942, where a check is made against one or more person identification systems, e.g., commercial systems used by private companies and/or law enforcement to identify individuals from images.

If in step 942 it is determined that the altered image works well against artificial intelligence (AI) individual detection systems, e.g., as evidence by a failure of all or a majority of the systems to accurately recognize the individual person shown in the altered image, the altered image is deemed acceptable and operation proceeds from step 942 to step 944. However, if in step 942 the altered image performs poorly against AI individual detection system, e.g., the person is recognized by a majority of AI system used to check the image in step 942, then the altered image is rejected and deleted and operation proceeds via connecting node B 948 back to step 934 so that a different altered image can be generated for distribution.

If in step 940 it was determined that the generated, i.e., altered, image was not an image of an individual, e.g., it was an image of an object such as a plane, operation proceeds from step 940 directly to step 944.

In step 944 the altered image is displayed to a user for approval. This can involve sending the image to a user device for display and displaying the altered image to the user. In this way the user will not be surprised by images which are distributed and is given an opportunity to reject an altered image thereby preventing its distribution.

Operation proceeds from step 944 to step 946 in which a check is made to determine if the user approved of the altered image. An affirmative approval from the user or no response within a predetermined amount of time is interpreted in some embodiments as approval. If the user sends a rejection notice in response to display of the altered image, step 946 detects the rejection and the altered image is discarded and a new altered image is generated as a result of operation proceeding via connecting node B 948 to step 934.

In the case where user approval of the generated altered image is determined in step 946, operation proceeds to step 950. In step 950 the generated image is stored for distribution. The stored image includes the intentionally altered image content along with, in some cases, false date, time and/or location information. In addition, in some cases the image is tagged as corresponding to a person or object which it does not accurately represent. Such tag information may be, and sometimes is, incorporated into the content, e.g., altered image, as metadata.

Operation proceeds from step 950 to step 952, in which a check is made to determine if the obfuscation, e.g., protection, plan for the received content being processed required the generation of additional altered images, e.g., to satisfy the determined number of altered images to be generated and distributed.

If in step 952 it is determined that additional altered images are to be generated for distribution, operation proceeds via connecting node B 948 to step 934 so that another altered image can be generated for distribution purposes. If in step 952 it is determined that additional altered images need not be generated, operation proceeds to return step 954, in which the generated altered images are returned for distribution. Determined distribution dates and website information are also returned to the main routine in some embodiments so that the generated altered images can be distributed based on a distribution schedule to the web sites for which the images were generated. The images and related distribution information can be, and sometimes are, stored in memory in a user record so that they can be accessed and distributed according to the developed obfuscation plan.

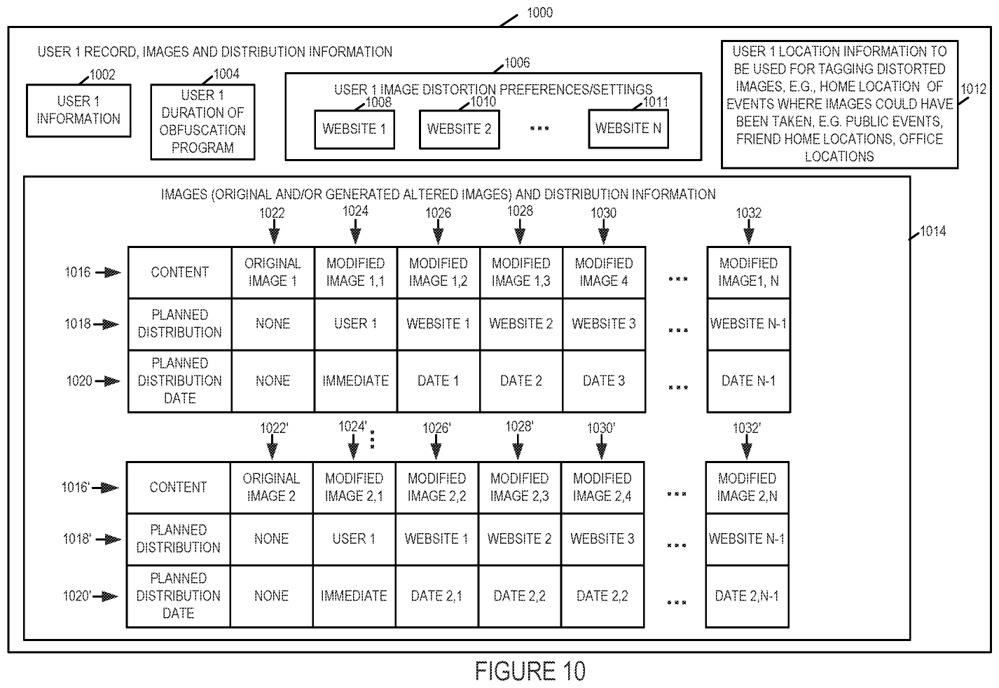

FIG. 10 illustrates a user record 1000 which is stored in memory in the user device and/or content processing and security system and which includes alteration information, altered images and distribution schedule information associated with a first exemplary user, user 1. The record 1000 includes user information 1002 identifying the user, e.g., person, to which the record corresponds. The record 1000 also includes obfuscation program duration information 1004, e.g., indicating a number of months or a time period for which the user has subscribed to a biometric obfuscation program or service. The record 1000 also includes image distortion preference settings 1006 with different distortions or amounts of distortions being specified for different web sites. Distortion information to be used for generating images for distribution to website 1, e.g., Facebook, is included in information 1008 while different distortion information is specified in information 1010 for website 2 and still other distortion information is specified in information 1011 corresponding to website N. The distortion information corresponding to a website is accessed and used when distorting an image corresponding to user 1 for distribution to the corresponding website.

User record 1000 also includes user location information 1012 to be used for tagging distorted images, the location information includes, for example, the location of User 1's home, and the location of events which images could have been taken, e.g., public events User 1 attended or regularly attends.

User 1 record 1000 also includes information and images 1014 corresponding to an active obfuscation program. The stored information and images 1014 includes data corresponding to a first image, Image 1 and a second Image 2, provided by User 1 for use in the obfuscation program being implemented on the user's behalf.

The information and data corresponding to Image 1 is shown in rows 1016, 1018, 1020 while the information and data corresponding to Image 2 is shown in rows 1016′, 1018′ and 1020′.

Row 1016 represents stored content to be distributed. In column 1022 original image 1 is stored. In row 1016 column 1024 modified image 1,1 is stored. The first number identifies the original image from which the altered, e.g., modified image was generated while the second number indicates the modified version of the original image which is stored. In Row 1016, column 1026 modified image 1,2 is stored, In row 1016, column 1028 modified image 1,3 is stored, In row 1016, column 1030 modified image 1,4 is stored. In row 1016, column 1032 modified image 1,N is stored.

In row 1018 distribution information is included in each column which indicates where, e.g., which website, the altered image stored in the same column is to be distributed. Row 1018 column 1022 shows that the original unhalted image is not to be distributed. that modified image 1,1 is to be distributed to the User 1 user device and that modified image 1,2 is to be distributed to Website 1 and that modified image 1,3 is to be distributed to website 3. The other columns include the distribution target for the modified images listed in those columns.

Row 1020 is used to indicate a planned, e.g., scheduled, distribution date of the image stored in the column. The original image 1 is not to be distributed thus none is shown for the scheduled distribution date corresponding to row 1020 column 1022. The first modified image, Image 1,1 is scheduled to be distributed immediately, e.g., as soon as available, so that the user can post it as he or she sees fit. Modified image 1,2 is scheduled to be distributed on Date 1 to Website 1, while modified image 1,3 is scheduled to be distributed to on date 2 to Website 2. While altered images may be created at the same time from the same image, e.g., Image 1, they can be distributed in accordance with the invention on different dates and to different Web sites given the appearance that they correspond to different events, locations and/or different capture times. The schedule information allows for the distribution to be implemented in accordance with the invention in accordance with an active obfuscation program or plan.

The second set of information and images is similar to the first set and primes are added to similar information to identify similar content. For example row 1016′ includes original and altered images corresponding to Image 2, row 1018′ includes distribution site information and row 1020′ includes scheduled distribution date information.

A variety of variations on the above described methods, systems and embodiments are possible.

In some embodiments the described system(s) are intended to provide novice users (non-technical, non-artists) the ability to easily and rapidly alter visual media (which may be a single image, animation composed of multiple still images, or an otherwise-encoded series of visual data to represent a moving picture) in a way so as to render it ill-suited for biometric feature extraction, via the use of a networked computer architecture that takes the source visual media along with user options in order to craft visual output (e.g. prepared files) that can be used for distribution to channels that may be outside a user's direct control. This system will make use of modern networking to enable a user to rapidly prepare these changes without the need to bring along sophisticated hardware or software, or to spend great lengths of time operating same. Furthermore, this networked approach attempts to validate its output against target biometric feature extraction systems which are automatically triggered on the output file to verify the successful alteration of the original data.

The user interface for this networked system in some embodiments will provide a cross-platform means of interaction, including both an application programming interface (API) suitable for access through bespoke software applications or through generic web browsing applications such as the popular Google Chrome, Microsoft Internet Explorer, and Mozilla Firefox programs that are commonly available both on consumer desktop workstations and mobile devices alike. Common and/or bespoke networking applications will be used for communication with the processing server(s) and to both send, review, and receive associated input/output or configuration data.

Users are provided with a variety of options for the modification/alteration of their image of varying degrees of deviation from the original source image, such as a set of visual “slider” interfaces that allow an acceptable deviation for various anatomical details such as the positioning and rotation of facial features or to control the “intensity” of modifications to background detail in the imagery. In addition to the direct “morphing” or subtraction of pre-existing elements, manipulation of the source imagery may include the addition of elements that are typically found to be a novelty in appearance and may modify or obscure the image subject (such as the inclusion of additional visual embellishments like dog/cat ears or other animal features; the addition of anatomical patterns such as “happy faces” or masklike imagery; angelic halos, sunglasses, headwear, jewelry and clothes-like/costume-like accessories; makeup-like effects; additional iconography, text, and image/sub-image components including watermarks; and/or visual artifacts such as bokeh, bloom, or lens effects).

Many elements with deceptive value (such as heart-shaped iconography placed over a subject's eyes) would not likely interfere with a human viewer's appreciation of the subject and may indeed raise the general appeal of the image, but could still introduce significant errors or cause misclassification for an image recognition or biometric extraction system. Depending on the visual effects or alterations being applied, the user may be able to provide additional instruction or configuration to the processing server(s) in order to adjust the positioning, translation, intensity, transparency, frequency, size, color, or general appearance of the effect. Not all manipulation need be particularly overt or immediately noticeable by a human observer. The introduction of static-like effects or subtle image artifacts, arbitrary adjustment of pixels (in color, intensity, contrast, patterns/constellations, position, etc), or manipulation of visual data that is still generally unnoticed or overlooked by human observers (such as image metadata or encoding) can be used to cause desirable disruptive effects on image recognition and biometric feature extraction systems.

In addition to modifying visual data in order to introduce errors in recognition/biometric services so as to make the images unrecognizable or difficult to identify a particular individual image manipulation may also perform adjustments in order to make images be miss-recognized, e.g., so that a different individual from the one included in the original image is identified if the resulting processed image is subject to a user identification operation. This manipulation approach attempts to modify a user's image in such a way that they are intentionally given misleading features, or the visual data is adjusted such that a user's image will be mis-categorized or recognized as something/someone else. For the purpose of this manipulation, user settings/expectations may tolerate more substantial deviation from what is a desirable image from an ordinary human observer's perspective. These manipulations, which may encompass all or some of the aforementioned techniques, will be performed in such a way as to lead image recognition and biometric extraction systems to mis-associate characteristics with the user (which may have the ideal effect of introducing error into long-term processing systems). This can lead to intentional misclassification of the user by those systems in the future; for example, a long-running database of extracted biometric features for the user may be provided with manipulated visual data that conflicts with its currently-stored recognition parameters by crafting images that misrepresent the user's facial proportions, skin tone, eye color, etc. by varying degrees. If these images purporting to be the user are intentionally distributed (including via hosting to the user's social media and public internet-accessible accounts, including the use of “tagging” those images to identify them as representing him/herself) it may intensify the disruptive effect on automated image collection routines employed by image recognition and biometric extraction systems.

The web server(s) that interface with users may themselves invoke related processing via other networked components. These components offer additional feature processing capability, sometimes referred to as services or microservices, to perform a related subtask for the overall workflow, and may include additional visual media manipulation options or verification capability.

To develop confidence in the successful modification of source visuals and provide useful feedback to the user, a verification component will attempt to process the modified output as input to various image recognition algorithms and services. The use of networked component adapters will offer access to both “native” image recognition systems such as a capability incorporated via open-source libraries and systems hosted in confederation with the image manipulation routines, as well as support for external “third-party” recognition systems. External image recognition systems include publicly-available image recognition and search services, as well as those that may be available through the user's internet-enabled service accounts including, e.g., social media platforms such as Facebook, etc., and may by design include the very image/biometric processing systems that image alteration is intended to defeat. Users will have the opportunity to “link to” these services as appropriate (including API-key or other access methods) in order to provide the system with an interface to conduct verification testing.

As image recognition technology evolves and changes over time and each will vary on the specific attributes that are most critical for successful recognition, the use of self-correcting image manipulation algorithms fed by the use of verification testing will allow the manipulation system to properly adjust or self-calibrate. This self-adjustment process will produce several different variations of the altered image to be tested against the reference recognition systems utilizing adjustable parameters, thereby leading to dynamic discovery of what techniques are most successful at defeating the current algorithms being employed. For instance, this approach may discern that a contemporary image recognition system is most susceptible to error introduced via the addition of false face-like patterns but is deceived less by text, and appropriately emphasize the face-like patterns to maximize the disruptive effects. The current best approaches for defeating any particular image-recognition or biometric extraction technology may or may not be stored on the manipulation servers directly, and could allow the user interfaces to utilize pre-configured “suggestions” for visual alterations/effects intended to effectively defeat those technologies. These configuration suggestions may also come in the form of software updates for the user interface components, the main manipulation server components, and/or the micro-service components.

In various embodiments nodes described herein are implemented using one or more modules to perform the steps corresponding to one or more methods of the present invention, for example, signal reception, signal processing, determinations, message generation and/or transmission steps. Thus, in some embodiments various features of the present invention are implemented using modules. Such modules may be implemented using software, hardware or a combination of software and hardware. Many of the above-described methods or method steps can be implemented using machine executable instructions, such as software, included in a machine-readable medium such as a memory device, e.g., RAM, floppy disk, etc. to control a machine, e.g., general purpose computer with or without additional hardware, to implement all or portions of the above-described methods, e.g., in one or more nodes. Accordingly, among other things, the present invention is directed to a machine-readable medium including machine executable instructions for causing a machine, e.g., processor and associated hardware, to perform one or more of the steps of the above-described method(s)

Numerous additional variations on the methods and apparatus of the present invention described above will be apparent to those skilled in the art in view of the above description of the invention. Such variations are to be considered within the scope of the invention. The methods and apparatus of the present invention may be, and in various embodiments are, used with CDMA, orthogonal frequency division multiplexing (OFDM), and/or various other types of communications techniques which may be used to provide wireless communications links between access nodes and mobile nodes and/or between beacon transmitters and mobile nodes. In some embodiments the access nodes are implemented as base stations which establish communications links with mobile nodes using OFDM and/or CDMA. In various embodiments the mobile nodes are implemented as notebook computers, personal data assistants (PDAs), or other portable devices including receiver/transmitter circuits and logic and/or routines, for implementing the methods of the present invention

Some embodiments are directed a non-transitory computer readable medium embodying a set of software instructions, e.g., computer executable instructions, for controlling a computer or other device to communicate information.

The techniques of various embodiments may be implemented using software, hardware and/or a combination of software and hardware. Various embodiments are directed to apparatus, e.g., a server such as an emergency management server. Various embodiments are also directed to methods, e.g., a method of providing emergency related information. Various embodiments are also directed to a non-transitory machine, e.g., computer, readable medium, e.g., ROM, RAM, CDs, hard discs, etc., which include machine readable instructions for controlling a machine to implement one or more steps of a method.

As discussed above various features of the present invention are implemented using modules. Such modules may, and in some embodiments are, implemented as software modules. In other embodiments the modules are implemented in hardware. In still other embodiments the modules are implemented using a combination of software and hardware. In some embodiments the modules are implemented as individual circuits with each module being implemented as a circuit for performing the function to which the module corresponds. A wide variety of embodiments are contemplated including some embodiments where different modules are implemented differently, e.g., some in hardware, some in software, and some using a combination of hardware and software. It should also be noted that routines and/or subroutines, or some of the steps performed by such routines, may be implemented in dedicated hardware as opposed to software executed on a general purpose processor. Such embodiments remain within the scope of the present invention. Many of the above-described methods or method steps can be implemented using machine executable instructions, such as software, included in a machine-readable medium such as a memory device, e.g., RAM, floppy disk, etc. to control a machine, e.g., general purpose computer with or without additional hardware, to implement all or portions of the above-described methods. Accordingly, among other things, the present invention is directed to a machine-readable medium including machine executable instructions for causing a machine, e.g., processor and associated hardware, to perform one or more of the steps of the above-described method(s).

The techniques of the present invention may be implemented using software, hardware and/or a combination of software and hardware. The present invention is directed to apparatus, e.g., a server, a beacon transmitter, mobile nodes such as mobile terminals, non-management user devices, management person user devices, base stations, and a communications system which implement the present invention. It is also directed to methods, e.g., method of controlling and/or operating a server, a beacon transmitter, mobile nodes including user devices, base stations and/or communications systems, e.g., hosts, in accordance with the present invention. The present invention is also directed to machine readable medium, e.g., ROM, RAM, CDs, hard discs, etc., which include machine readable instructions for controlling a machine to implement one or more steps in accordance with the present invention.

Numerous additional variations on the methods and apparatus of the various embodiments described above will be apparent to those skilled in the art in view of the above description. Such variations are to be considered within the scope.

What is claimed is:

1. A method of processing content including a first image or audio, the method comprising:
intentionally distorting at least some of the content, said distortion making it more difficult to identify an individual or object to which the first image or audio corresponds from the distorted content than from the content being processed; and
providing the intentionally distorted content to a user device for distribution or distributing the distorted content.

2. The method of claim 1, wherein intentionally distorting at least some content includes generating multiple different distorted images from the first image.

3. The method of claim 2, wherein the posting of distorted images is part of an active biometric obfuscation program in which the user providing the content has chosen to participate.

4. The method of claim 1, wherein said step of intentionally distorting at least some content is performed in accordance with one or more user distortion settings corresponding to a site or group to which distorted content is to be distributed.

5. The method of claim 4, wherein said content is received with information indicating the intended group or web site to which the content is to be distributed and the user to which the content corresponds.

6. The method of claim 5, further comprising:
using the user and group or web site to which the content is to be distributed to identify information included in a user record to be used to control the amount and/or type of distortion to be applied (e.g., the system applies distortion in accordance with the settings in the user record corresponding to the user to which the content corresponds).

7. The method of claim 1, wherein the content includes an image, the method further comprising:
generating an obfuscation plan corresponding to said image.

8. The method of claim 7, wherein generating an obfuscation plan includes:
performing a search to determine a number of publicly available accurate images corresponding to an individual or object to which the first image corresponds; and
determining a number of distorted images to generate and distribute based on the determined number of publicly available images.

9. The method of claim 8, further comprising:
determining a period of time over which to distribute generated distorted images corresponding to the first image.

10. The method of claim 9, further comprising:
generating said number of distorted images; and
wherein providing the intentionally distorted content to a user device for distribution or distributing the distorted content includes:
distributing at least some of said generated distorted images to different web sites at different times in accordance with said obfuscation plan.

11. The method of claim 2, wherein providing the intentionally distorted content to a user device for distribution or distributing the distorted content includes posting different distorted images to different web sites.

12. A system processing content including a first image or audio, the system comprising:
memory for storing said content; and
a processor configured to:
intentionally distorting at least some of the content, said distortion making it more difficult to identify an individual or object to which the first image or audio corresponds from the distorted content than from the content being processed; and
providing the intentionally distorted content to a user device for distribution or distributing the distorted content.

13. The system of claim 12, wherein intentionally distorting at least some content includes generating multiple different distorted images from the first image.

14. The system of claim 12, wherein the posting of distorted images is part of an active biometric obfuscation program in which the user providing the content has chosen to participate.
